(19) United States
(12) Patent Application Publication
(10) Pub. No.: US 2026/0084188 A1
(43) Pub. Date: Mar. 26, 2026

(54) CLEANING DEVICE INCLUDING LASER MARKING UNIT

(71) Applicant: Mu-tech Precision Co., Ltd., Kaohsiung City (TW)

(72) Inventors: Chih-Jen YANG, Taichung City (TW); Kuo-Chang SHIH, Pingtung County (TW); Fan-Ching CHANG, Taichung City (TW)

(73) Assignee: Mu-tech Precision Co., Ltd., Kaohsiung City (TW)

(21) Appl. No.: 19/260,877

(22) Filed: Jul. 7, 2025

(30) Foreign Application Priority Data
Sep. 26, 2024 (TW) 113136670
May 20, 2025 (TW) 114118877

(51) Int. Cl. B08B 3/02; B08B 3/04; B08B 3/08; B08B 5/02; B08B 5/04; G01N 21/88

(52) U.S. Cl. CPC B08B 3/024; B08B 3/041; B08B 3/08; B08B 5/023; B08B 5/043; G01N 21/8806; B08B 2203/0217

(57) ABSTRACT

A cleaning device includes a base unit that supports a die unit and a carrier plate that is movable relative to the drive unit. A nozzle seat is connected to the carrier plate. A nozzle is fixed to the nozzle seat to spray a cleaning solution onto a die unit. A laser marking unit is connected to the carrier plate and is adapted to project a laser beam to the cleaning solution sprayed from the nozzle onto the die unit.

### CROSS-REFERENCE TO RELATED APPLICATION

This application claims priorities to Taiwanese Invention Patent Application No. 113136670, filed on Sep. 26, 2024, and Taiwanese Invention Patent Application No. 114118877, filed on May 20, 2025, the entire disclosure of which is incorporated by reference herein.

### FIELD

The disclosure relates to a cleaning device, and more particularly to a cleaning device including a laser marking unit.

### BACKGROUND

With development of wafer packaging technology, electric components on a wafer surface are increasingly precise. The electric components may be easily damaged by contaminants such as dusts and small particles attached to them. An existing cleaning device is used to remove the contaminants from the wafer surface.

In general, a wafer is cleaned using a transparent cleaning solution. However, when cleaning the wafer using the existing cleaning device with the transparent cleaning solution, it is difficult for an operator to see whether the wafer is being properly cleaned. Therefore, there is room for improvement on the existing cleaning device.

### SUMMARY

Therefore, an object of the disclosure is to provide a cleaning device that can alleviate at least one of the drawbacks of the prior art.

According to the disclosure, a cleaning device is adapted to clean a die unit. The cleaning device includes a base unit, a drive unit, a nozzle unit, and a laser marking unit

The base unit is adapted to support the die unit thereon.

The drive unit includes a carrier plate that is movable relative to the base unit in a left-right direction, in a front-rear direction substantially perpendicular to the left-right direction, and in a top-bottom direction substantially perpendicular to the left-right direction and the front-rear direction.

The nozzle unit includes a nozzle seat and at least one nozzle. The nozzle seat is connected to a bottom end of the carrier plate and is adjacent to the base unit. The at least one nozzle is fixed to the nozzle seat and is adapted to spray a cleaning solution onto the die unit.

The laser marking unit is connected to a front end of the carrier plate and is adapted to project a laser beam to the cleaning solution sprayed from the at least one nozzle onto the die unit.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view illustrating a cleaning device according to a first embodiment of the disclosure adapted to clean dies and a carrying tray of a die unit.

FIG. 2 is a side view of the first embodiment illustrating the cleaning device, the dies, and the carrying tray.

FIG. 3 is a front view of the first embodiment illustrating the cleaning device.

FIG. 4 is a partly sectional view taken along line IV-IV of FIG. 3.

FIG. 5 is a fragmentary enlarged perspective view of the first embodiment illustrating the cleaning device, the dies, and the carrying tray.

FIG. 6 is a perspective view illustrating a cleaning device according to a second embodiment of the disclosure adapted to clean the dies and the carrying tray.

FIG. 7 is a perspective view illustrating a cleaning device according to a third embodiment of the disclosure adapted to clean a single die.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

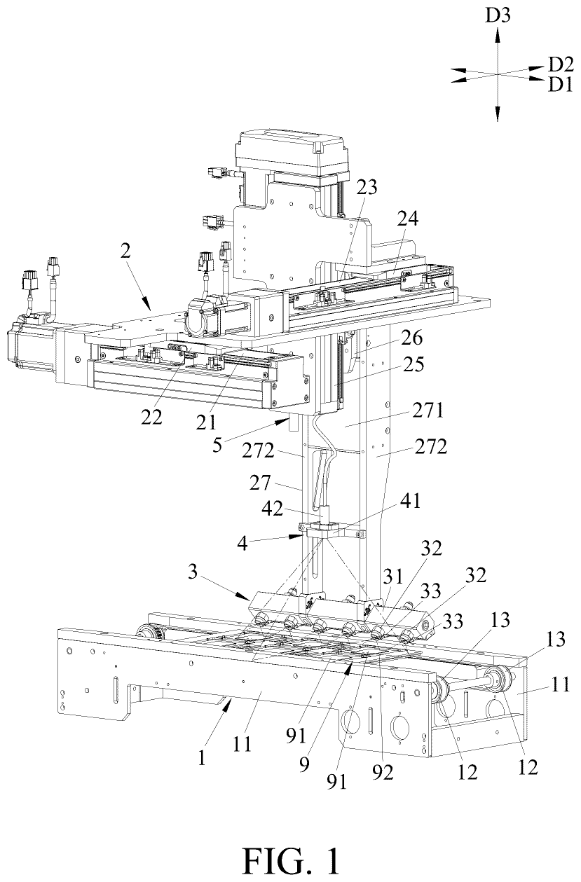

Referring to FIGS. 1 to 3, a cleaning device according to a first embodiment of the disclosure is adapted to clean a die unit 9. In this embodiment, the die unit 9 includes a carrying tray 92 and a plurality of dies 91 carried by the carrying tray 92. In some embodiments, the die unit 9 may include only one die 91 and the carrying tray 92 is omitted therefrom. It should be mentioned that the die 91 may be integrated with a large substrate or a Chip-on-Wafer-on-Substrate (CoWoS).

In the first embodiment, the cleaning device of the disclosure includes a base unit 1, a drive unit 2, a nozzle unit 3, a laser marking unit 4, and an image-capture unit 5.

The base unit 1 is adapted to support the die unit 9 thereon. In this embodiment, the base unit 1 includes two base plates 11, two roller sets 12, and two conveyance belts 13. The two base plates 11 extend in a left-right direction (D1) and are spaced apart from each other in a front-rear direction (D2) substantially perpendicular to the left-right direction (D1). The two roller sets 12 are respectively and rotatably disposed on the two base plates 11. The two conveyance belts 13 are respectively trained on the two roller sets 12 and are adapted to support and convey the die unit 9.

The drive unit 2 includes a left-right mount 21, a left-right slide seat 22, a front-rear mount 23, a front-rear slide seat 24, a top-bottom mount 25, a top-bottom slide seat 26, and a carrier plate 27. The left-right slide seat 22 is disposed on the left-right mount 21 and is slidable relative to the left-right mount 21 in the left-right direction (D1). The front-rear mount 23 is fixed to the left-right slide seat 22. The front-rear slide seat 24 is disposed on the front-rear mount 23 and is slidable relative to the front-rear mount 23 in the front-rear direction (D2). The top-bottom mount 25 is fixed to the front-rear slide seat 24. The top-bottom slide seat 26 is disposed on the top-bottom mount 25 and is slidable relative to the top-bottom mount 25 in a top-bottom direction (D3) substantially perpendicular to the left-right direction (D2) and the front-rear direction (D1). The carrier plate 27 is fixed to the top-bottom slide seat 26. As a result, the carrier plate 27 is movable relative to the base unit 1 in the left-right direction (D1), in the front-rear direction (D2), and in the top-bottom direction (D3).

In this embodiment the carrier plate 27 includes a plate body 271 and two extension portions 272 that are connected to the plate body 271 and that are elongated in the top-bottom direction (D3).

The nozzle unit 3 includes a nozzle seat 31 that is connected to a bottom end of the carrier plate 27 and that is adjacent to the base unit 1, a plurality of nozzles 32 that are fixed to the nozzle seat 31, and a plurality of auxiliary nozzles 33 that are fixed to the nozzle seat 31.

The nozzle seat 31 is rotatably disposed between the two extension portions 272, and allows a cleaning solution to pass through a soft conduit (not shown) for cleaning the die unit 9.

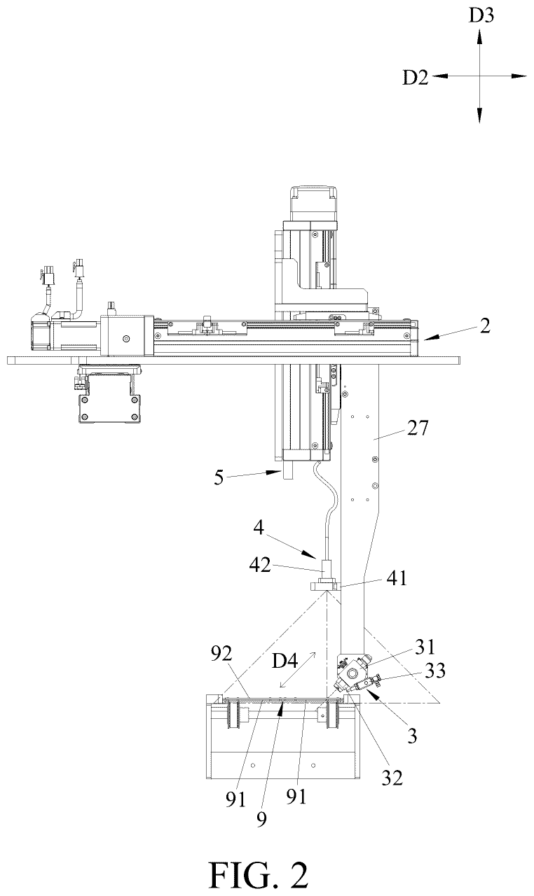

As shown in FIG. 2, the plurality of nozzles 32 are adapted to spray the cleaning solution onto the die unit 9 along an oblique direction (D4) that is inclined relative to the front-rear direction (D2) and the top-bottom direction (D3).

The plurality of auxiliary nozzles 33 are connected to a blower machine (not shown), are oriented toward the die unit 9, and are adapted to spray air to the plurality of dies 91 and the carrying tray 92 of the die unit 9.

In this embodiment, a quantity of the plurality of nozzles 32 and a quantity of the plurality of auxiliary nozzles 33 are both six. The cleaning solution is a Standard Clean-1 (SC-1) solution, a Standard Clean-2 (SC-2) solution, or another chemical cleaning solution. In other embodiments, the quantity of the plurality of nozzles 32 and the quantity of the plurality of auxiliary nozzles 33 may be one, two, three, four, five, or greater than six.

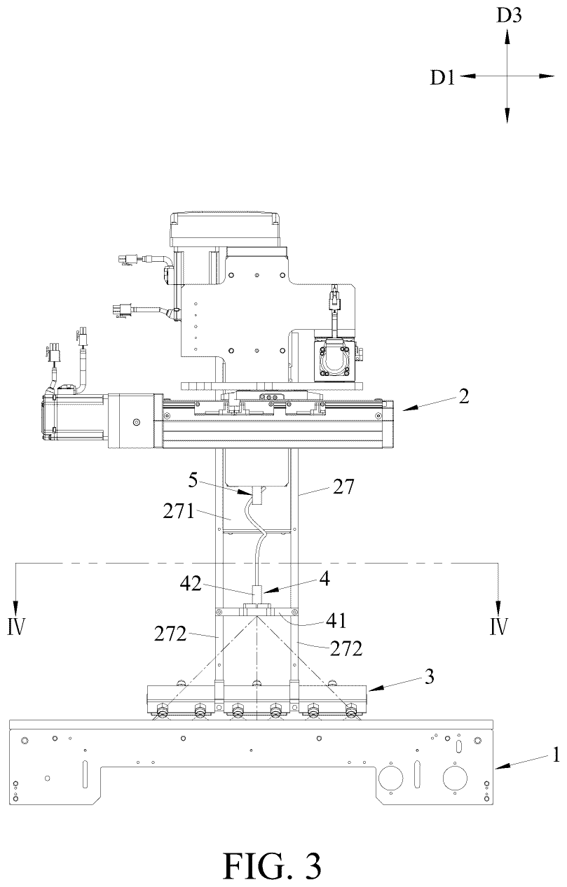

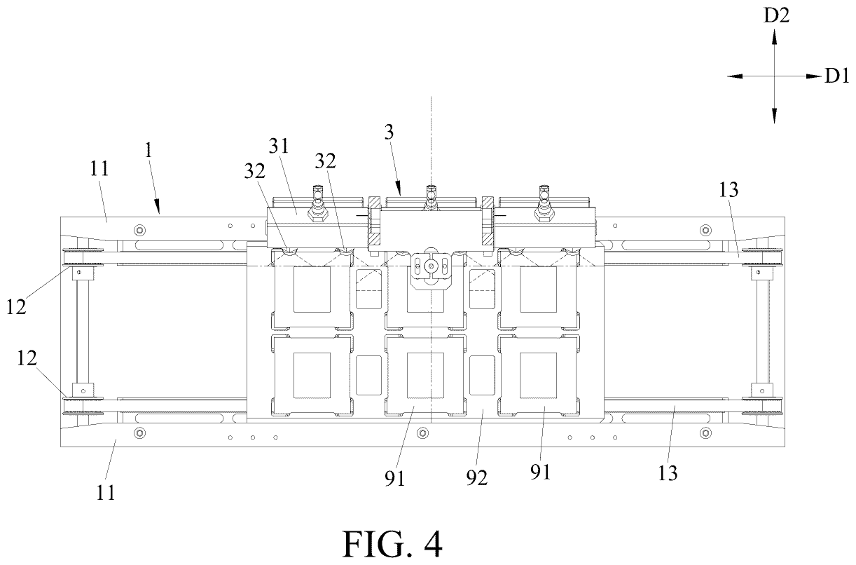

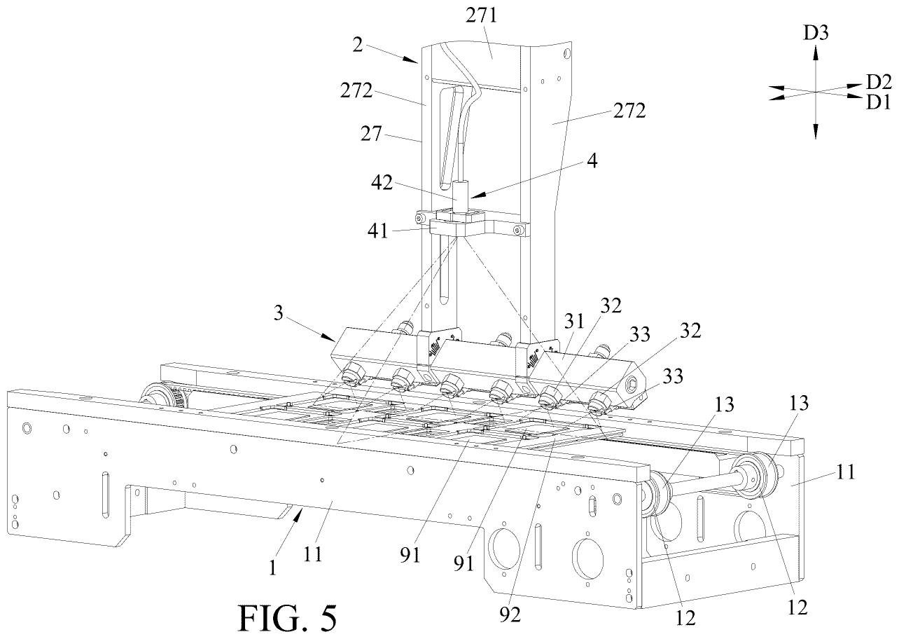

Referring to FIGS. 3, 4, and 5, the laser marking unit 4 is connected to a front end of the carrier plate 27 and adapted to project a cross-shaped laser beam to the cleaning solution sprayed from the plurality of nozzles 32 onto the plurality of dies 91 and the carrying tray 92 of the die unit 9.

The laser marking unit 4 includes a laser mount 41 and a laser emitter 42. The laser mount 41 is connected to the front end of the carrier plate 27. The laser emitter 42 is fixed to the laser mount 41 and is adapted to be oriented toward the die unit 9 in the top-bottom direction (D3) so as to project the cross-shaped laser beam to the cleaning solution sprayed from the plurality of nozzles 32 onto the plurality of dies 91 and the carrying tray 92 of the die unit 9. In this embodiment, the laser emitter 42 is a red laser diode emitter.

The image-capture unit 5 is disposed on a bottom side of the top-bottom mount 25 of the drive unit 2, and is adapted to generate sequential pictures of the plurality of dies 91 and the carrying tray 92 of the die unit 9 cleaned by the cleaning solution sprayed from the plurality of nozzles 32.

The sequential pictures generated by the image-capture unit 5 indicate that the cross-shaped laser beam from the laser marking unit 4 are projected to the cleaning solution sprayed from the plurality of nozzles 32 onto the plurality of dies 91 and the carrying tray 92 during a cleaning process of the plurality of dies 91, thereby allowing an operator to inspect the cleaning process of the plurality of dies 91 after the cleaning process is completed.

In use, because the laser marking unit 4 projects the cross-shaped laser beam to the cleaning solution sprayed from the plurality of nozzles 32 onto the plurality of dies 91 and the carrying tray 92, whether the sequential pictures generated by the image-capture unit 5 are checked on site or after the completion of the cleaning process, the operator is able to confirm if the cleaning process of the plurality of dies 91 meets the requirements.

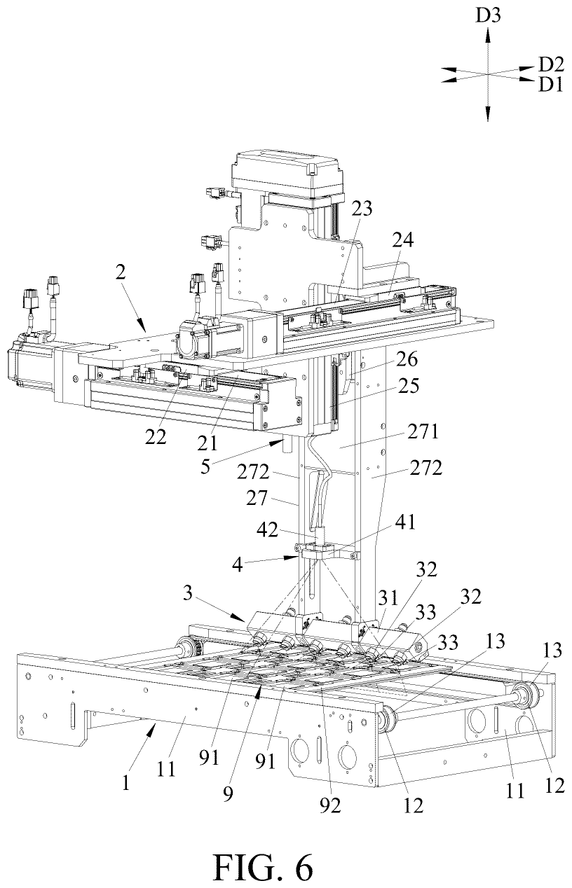

FIG. 6 illustrates a cleaning device according to a second embodiment of the disclosure, which has a structure generally similar to that of the first embodiment.

The difference between the two embodiments resides in that a distance between the two base plates 11 of the second embodiment in the front-rear direction (D2) is greater than a distance between the two base plates 11 of the first embodiment in the front-rear direction (D2) for cleaning the carrying trays 92 with different widths. As a result, by virtue of the laser marking unit 4 projecting the cross-shaped laser beam to the cleaning solution sprayed from the plurality of nozzles 32 onto the plurality of dies 91 and the carrying tray 92, the operator may conveniently confirm if the cleaning process of the plurality of dies 91 meets the requirements.

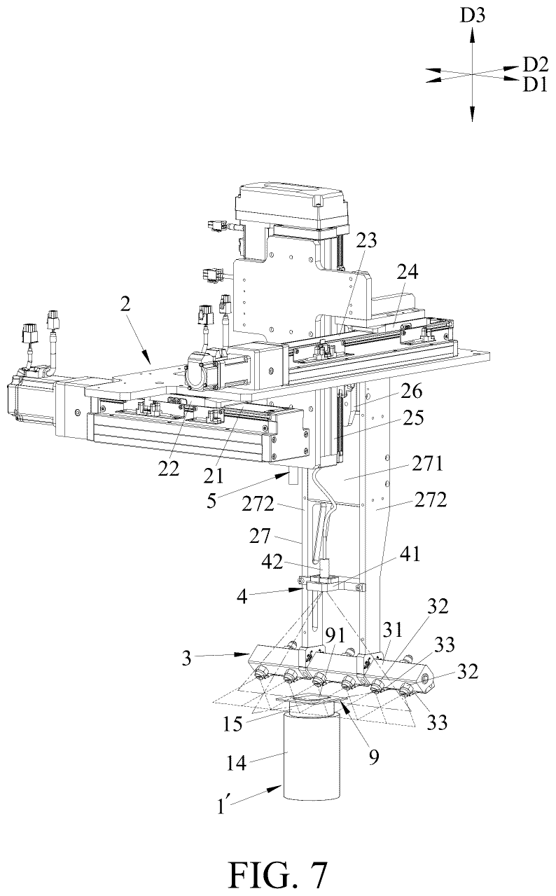

FIG. 7 illustrates a cleaning device according to a third embodiment of the disclosure, which is also adapted to clean the die unit 9 and has a structure generally similar to that of the first embodiment. However, the base unit 1′ of the third embodiment is different from the base unit 1 of the first embodiment. In addition, the die unit 9 only includes the die 91 or a wafer (not shown).

In the third embodiment, the base unit 1′ includes a base body 14 and a vacuum sucking member 15 that is rotatably disposed on the base body 14 and that is adapted to suck the die unit 9 including the die 91 or the wafer (not shown). As a result, the die 91 or the wafer (not shown) is sucked by and rotates with the vacuum sucking member 15 so as to be cleaned by the nozzle unit 3. As a result, by virtue of the laser marking unit 4 projecting the cross-shaped laser beam to the cleaning solution sprayed from the plurality of nozzles 32 onto the die 91 or the wafer (not shown), the operator may conveniently confirm if the cleaning process of the die 91 or the wafer (not shown) meets the requirements.

In summary, the cleaning device has the following advantages.

1. Because the laser marking unit 4 is connected to the front end of the carrier plate 27, and because the nozzle seat 31 is connected to the bottom end of the carrier plate 27, the laser marking unit 4 and the nozzle seat 31 are co-movable with the carrier plate 27, and the laser marking unit 4 projects the cross-shaped laser beam to the cleaning solution sprayed from the plurality of nozzles 32, thereby facilitating confirmation of the cleaning process of the die unit 9.

2. By virtue of the image-capture unit 5 generating the sequential pictures of the wafer 9 cleaned by the nozzle unit 3, the operator may confirm the cleaning process of the wafer 9 after the cleaning process is completed.

3. In the third embodiment, because the base unit 1′ includes the base body 14 and the vacuum sucking member 15 that is rotatably disposed on the base body 14 and that is adapted to suck the die unit 9, the die unit 9 is sucked by and rotates with the vacuum sucking member 15 relative to the base body 14 so as to be cleaned by the nozzle unit 3.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A cleaning device adapted to clean a die unit, said cleaning device comprising:
a base unit adapted to support the die unit thereon;
a drive unit including a carrier plate that is movable relative to said base unit in a left-right direction, in a front-rear direction substantially perpendicular to the left-right direction, and in a top-bottom direction substantially perpendicular to the left-right direction and the front-rear direction;
a nozzle unit including
a nozzle seat that is connected to a bottom end of said carrier plate and that is adjacent to said base unit, and
at least one nozzle that is fixed to said nozzle seat and that is adapted to spray a cleaning solution onto the die unit; and
a laser marking unit connected to a front end of said carrier plate and adapted to project a laser beam to the cleaning solution sprayed from said at least one nozzle onto the die unit.

2. The cleaning device as claimed in claim 1, wherein said laser marking unit is adapted to project a cross-shaped laser beam.

3. The cleaning device as claimed in claim 1, wherein said base unit includes
two base plates that extend in the left-right direction and that are spaced apart from each other in the front-rear direction,
two roller sets that are respectively and rotatably disposed on said two base plates, and
two conveyance belts that are respectively trained on said two roller sets and that are adapted to support and convey the die unit.

4. The cleaning device as claimed in claim 1, wherein said base unit includes
a base body, and
a vacuum sucking member that is rotatably disposed on said base body and that is adapted to suck the die unit.

5. The cleaning device as claimed in claim 1, further comprising an image-capture unit disposed on said drive unit, and adapted to generate sequential pictures of the die unit cleaned by the cleaning solution from said at least one nozzle.

6. The cleaning device as claimed in claim 1, wherein:
said carrier plate includes
a plate body, and
two extension portions that are connected to said plate body and that are elongated in the top-bottom direction;
said nozzle seat is rotatably disposed between said two extension portions;
said at least one nozzle is adapted to spray the cleaning solution onto the die unit along an oblique direction that is inclined relative to the front-rear direction and the top-bottom direction.

7. The cleaning device as claimed in claim 1, wherein said nozzle unit further includes at least one auxiliary nozzle that is fixed to said nozzle seat and that is adapted to spray air to the die unit.

8. The cleaning device as claimed in claim 1, wherein said laser marking unit includes
a laser mount that is connected to the front end of said carrier plate, and
a laser emitter that is fixed to said laser mount and that is adapted to be oriented toward the die unit in the top-bottom direction so as to project the laser beam to the cleaning solution sprayed from said at least one nozzle onto the die unit.

9. The cleaning device as claimed in claim 1, wherein:
said drive unit further includes
a left-right mount,
a left-right slide seat that is disposed on said left-right mount and that is slidable relative to said left-right mount in the left-right direction,
a front-rear mount that is fixed to said left-right slide seat,
a front-rear slide seat that is disposed on said front-rear mount and that is slidable relative to said front-rear mount in the front-rear direction,
a top-bottom mount that is fixed to said front-rear slide seat, and
a top-bottom slide seat that is disposed on said top-bottom mount and that is slidable relative to said top-bottom mount in the top-bottom direction; and
said carrier plate is fixed to said top-bottom slide seat.
